(19) United States
(12) Patent Application Publication
(10) Pub. No.: US 2008/0247067 A1
(43) Pub. Date: Oct. 9, 2008

(54) CATOPTRIC REDUCTION PROJECTION OPTICAL SYSTEM, EXPOSURE APPARATUS, AND METHOD FOR MANUFACTURING DEVICE

(75) Inventor: Takahiro Sasaki, Hiroshima-shi (JP)

Correspondence Address: MORGAN & FINNEGAN, L.L.P., 3 WORLD FINANCIAL CENTER, NEW YORK, NY, 10281-2101, US

(73) Assignee: CANON KABUSHIKI KAISHA, Tokyo (JP)

(21) Appl. No.: 12/061,158

(22) Filed: Apr. 2, 2008

(30) Foreign Application Priority Data
Apr. 6, 2007 (JP) 2007-100112

(51) Int. Cl. G02B 5/10

(52) U.S. Cl. 359/864

(57) ABSTRACT

A projection optical system is configured to project a reduced pattern of an object surface onto an image surface. The projection optical system includes, in order of reflecting light from the object surface, a first reflective surface having a concave surface shape, a second reflective surface having a convex surface shape, a third reflective surface having a concave surface shape, a fourth reflective surface, a fifth reflective surface, a sixth reflective surface, a seventh reflective surface, and an eighth reflective surface, and an aperture stop disposed on an optical path between the first reflective surface and the second reflective surface. An intermediate image is formed on an optical path between the fourth reflective surface and the fifth reflective surface. This configuration provides a projection optical system that has eight or more reflective surfaces and a high NA, and secures a disposing space for members, and exhibits a superior imaging performance.

### BACKGROUND OF THE INVENTION

The present invention relates to a projection optical system employed for an exposure apparatus, and more particularly, to a catoptric reduction projection optical system configured to expose a substrate such as a single crystal substrate for a semiconductor wafer and a glass substrate for a liquid crystal display (LCD) using ultra violet rays and extreme ultraviolet rays.

Due to the requirements of smaller and thinner electronic appliances in recent years, the demands for finer semiconductor devices mounted in the electronic appliances have been on the rise. For example, it is required that designing rules of a mask pattern should form an image of line and space (L & S) having a dimension of equal to or shorter than 0.1 μm over a wide range. The L & S is the image of line and space having the same width projected on a wafer when being exposed, and is an index for a resolution of exposure.

A projection exposure apparatus that is a typical exposure apparatus for manufacturing semiconductors includes a projection optical system therein configured to project a pattern of a mask or reticle (the present invention interchangeably uses these terms) onto a wafer. A resolution R (critical dimension with which an object can be accurately transferred) of the projection exposure apparatus is given using a wavelength of a light source and a numerical aperture (NA) of the projection optical system in the following expression.

R=k₁×λ/NA

Accordingly, as the wavelength becomes shorter, and as the NA becomes higher, the resolution improves. In recent years, a smaller resolution is required, and cannot be provided only by raising the NA. Thus, use of a short wavelength is expected to improve the resolution.

Currently, an exposure light source has been changing to employ a KrF excimer laser (with a wavelength of approximately 248 nm) and an ArF excimer laser (with a wavelength of approximately 193 nm). Further, extreme ultraviolet (EUV) light is now on the way to practical use.

However, a short wavelength of light limits an applicable lens material through which light passes. Therefore, heavy usage of refraction elements, which are lenses, is difficult, thereby making it advantageous to include a catoptric element, which is a mirror, in the projection optical system. Furthermore, no lens material can be used for the EU light as exposure light, and thereby it is unable to include a lens in the projection optical system.

Accordingly, one proposed projection optical system is a catoptric projection optical system that includes only mirrors, for example multilayer mirrors.

In the catoptric projection optical system, a mirror has multilayer films to improve a reflectance of the mirror. However, in order to improve the reflectance of the entire optical system, it is desirable that the number of mirrors is as small as possible. Additionally, in order to prevent mechanical interference between a mask and a wafer, it is desirable to constitute the projection system with an even number of mirrors such that all of the mirrors can be disposed between the mask and the wafer.

Moreover, a smaller the critical dimension (resolution) than ever is required for an EUV exposure apparatus, and thus a NA should be increased, for example, up to 0.3 for the wavelength of 13.5 nm. However, reducing a wavefront aberration is difficult for the conventional four or six mirrors. Then, increasing the number of mirrors to eight or so has become necessary in order to also improve the degree of freedom for the wavefront aberration correction (hereinafter, the specification may refer to this optical system as an eight-mirror system). The eight-mirror system of this kind is disclosed in Japanese Patent Laid-Open Nos. 2005-189248 and 2005-315918, U.S. Pat. No. 5,868,728, and the like.

Japanese Patent Laid-Open No. 2005-189248 discloses three typical projection optical systems constituted by eight mirrors for the EUV light in its embodiments. The projection optical system receives incident light from an object and forms an intermediate image with four mirrors constituted by a first mirror M1 having a concave surface shape, a second mirror M2 having a concave surface shape, a third mirror M3 having a convex surface shape and a fourth mirror M4 having a concave surface shape. Additionally, through a fifth mirror M5, a sixth mirror M6 having a concave surface shape, a seventh mirror M7 having a convex surface shape and an eighth mirror M8 having a concave surface shape, the light is re-imaged on an image surface. The projection optical system in the three embodiments disclosed in Japanese Patent Laid-Open No. 2005-189248 disposes an aperture stop is disposed on an optical path between the first mirror M1 and the second mirror M2.

Japanese Patent Laid-Open No. 2005-315918 discloses three typical projection optical systems that include eight mirrors for the EUV light in its embodiments. The projection optical system receives incident light from an object surface and forms an intermediate image with four mirrors that include a first mirror M1 having a concave surface shape, a second mirror M2 having a convex surface shape, a third mirror M3 having a concave surface shape and a fourth mirror M4 having a concave surface shape. Additionally, through a fifth mirror M5 having a concave surface shape, a sixth mirror M6, a seventh mirror M7 having a convex surface shape and an eighth mirror M8 having a concave surface shape, the light is re-imaged on the image surface. The projection optical system in the three embodiments disclosed in Japanese Patent Laid-Open No. 2005-315918 disposes an aperture stop on the second mirror M2.

U.S. Pat. No. 5,868,728 discloses one typical projection optical system that includes eight mirrors for the EUV light in its embodiment. The projection optical system receives incident light from an object surface and forms an intermediate image with five mirrors that include a first mirror M1 having a concave surface shape, a second mirror M2 having a convex surface shape, a third mirror M3 having a convex surface shape, a fourth mirror M4 having a concave surface shape and a fifth mirror M5 having a concave surface shape.

Additionally, through a sixth mirror M6 having a convex surface shape, a seventh mirror M7 having a convex surface shape and an eighth mirror M8 having a concave surface shape, the light is re-imaged on the image surface. This embodiment disposes an aperture stop on an optical path between the first mirror M1 and the second mirror M2.

Japanese Patent Laid-Open Nos. 2002-139672, 2005-189247, 2005-258457, and 2002-116382 disclose other projection optical systems that include eight mirrors.

As electronic circuits become further finer, a projection optical system having a higher NA, for example equal to or more than 0.3 of the NA, is required. Additionally, due to the necessity of designing freedom for aberration correction, the number of the mirrors has been increased from conventional six to eight, and thus the reflective surfaces are disposed to the extent that the optical path is crowded. Further, as the NA becomes higher, a diameter of luminous flux is increased. Accordingly a size of an effective aperture (optical effective portion, clear aperture) of each reflective surface (an effective diameter of each reflective surface) is also increased.

The aforementioned reasons have made it difficult to ensure the space for disposing members including the reflective surfaces, their holding mechanisms, cooling mechanisms and the like. Moreover, ensuring the space for disposing the members largely restricts designing, thereby making aberration correction difficult.

In the projection optical system disclosed in Japanese Patent Laid-Open No. 2005-189248, the concave surface of the second mirror M2 makes disposing the members difficult. It is due to the following reasons. Since the second mirror M2 has the concave surface, in order to make a Petzval sum closer to 0 to suppress a field curvature on the image surface, it is necessary to increase a curvature radius, or to reduce the power, of the first mirror M1 having the concave surface shape. Therefore, the diameter of the luminous flux emitted from the first mirror M1 is increased. Accordingly, a length between the second mirror M2 and the object surface is reduced as a size of an optical effective portion of the second mirror M2 is increased. Thus, ensuring the space for disposing the members becomes difficult near the second mirror M2.

Further, in the projection optical system described in Japanese Patent Laid-Open No. 2005-315918, since the size of the optical effective portion of the second mirror M2 is large, and since a place of the aperture stop coincides with a place of the second mirror M2, disposing the members is difficult near the second mirror M2. The first and second mirrors M1 and M2 are not powerful, thus the thick luminous flux having entered the first mirror M1 enters the second mirror M2 as it is. Therefore, the size of the optical effective portion of the second mirror M2 is increased.

Furthermore, generally, in order to ensure good imaging performance, an object-side telecentricity needs to be reduced. In this case, the luminous flux having entered the first mirror M1 from the object surface passes very closely to the aperture stop. In a case where the aperture stop coincides with the second mirror M2, the luminous flux passes very closely to the second mirror M2. The reasons described above make it impossible to ensure the space for disposing the members including the second mirror M2.

Moreover, in the projection optical system disclosed in U.S. Pat. No. 5,868,728, the third mirror has the convex surface shape to lead the luminous flux in a direction away from an optical axis, whereby ensuring a space latitude around the second mirror M2 and the third mirror M3. However, the convex surface of the third mirror M3 creates a problem in aberration correction. In this configuration, an incident angle of a ray onto the second mirror M2 having the convex surface is large. Thereby a positive astigmatism is likely to occur. Additionally, the third mirror M3 has the convex surface, and increases the positive astigmatism, and the fourth mirror M4 needs to generate a negative astigmatism in order to correct the aberration. Accordingly, the fourth mirror M4 should become powerful. Meanwhile, the fourth mirror M4 corrects an aberration of a field angle such as distortion, which makes it difficult to correct both of the astigmatism and distortion thereon. Accordingly, the distortion is likely to deteriorate, thereby limiting a size of an exposure region.

### BRIEF SUMMARY OF THE INVENTION

The present invention is directed to a projection optical system that has eight or more reflective surfaces and a high NA, and secures a disposing space for members, and exhibits a superior imaging performance.

A projection optical system according to one aspect of the present invention is configured to project a reduced image of a pattern on an object onto an image surface. The projection optical system includes, in order of reflecting light from the object surface, a first reflective surface having a concave surface shape, a second reflective surface having a convex surface shape, a third reflective surface having a concave surface shape, a fourth reflective surface, a fifth reflective surface, a sixth reflective surface, a seventh reflective surface, and an eighth reflective surface, and an aperture stop disposed on an optical path between the first reflective surface and the second reflective surface, wherein an intermediate image is formed on an optical path between the fourth reflective surface and the fifth reflective surface. It is preferable that the aperture stop is not located on the first reflective surface and the second reflective surface, that is, the position of the aperture stop does not coincide with those of the first and second reflective surfaces.

An exposure apparatus according to another aspect of the present invention includes an illumination optical system configured to illuminate a pattern of an object surface using light from a light source, and the above projection optical system configured to project a reduced image of the pattern on the object surface onto the image surface.

A method for manufacturing a device according to another aspect of the present invention includes the steps of exposing a substrate using the above exposure apparatus, and developing the substrate that has been exposed.

Other aspects of the present invention will become apparent from the following description and the attached drawings.

### BRIEF DESCRIPTION OF THE DRAWINGS

FIG. 1 is a cross-sectional view illustrating a configuration of a projection optical system according to Embodiment 1 of the present invention.

FIG. 2 is a cross-sectional view illustrating a configuration of a projection optical system according to Embodiment 2 of the present invention.

FIG. 3 is a cross-sectional view illustrating the configuration of a projection optical system according to Embodiment 3 of the present invention.

FIG. 4 is a diagram of a configuration illustrating an example of an exposure apparatus using the projection optical systems of Embodiments 1 to 3.

FIG. 5 is a flowchart for describing manufacturing devices including LCDs, CCDs, and semiconductor chips such as ICs and LSIs.

FIG. 6 is a flowchart in detail for describing wafer processing in step 4 shown in FIG. 5.

### DETAILED DESCRIPTION OF THE PREFERRED EMBODIMENTS

Exemplary embodiments of the present invention will hereinafter be described with reference to the accompanying drawings.

Firstly, the basic items common to each embodiment of the present invention will be described.

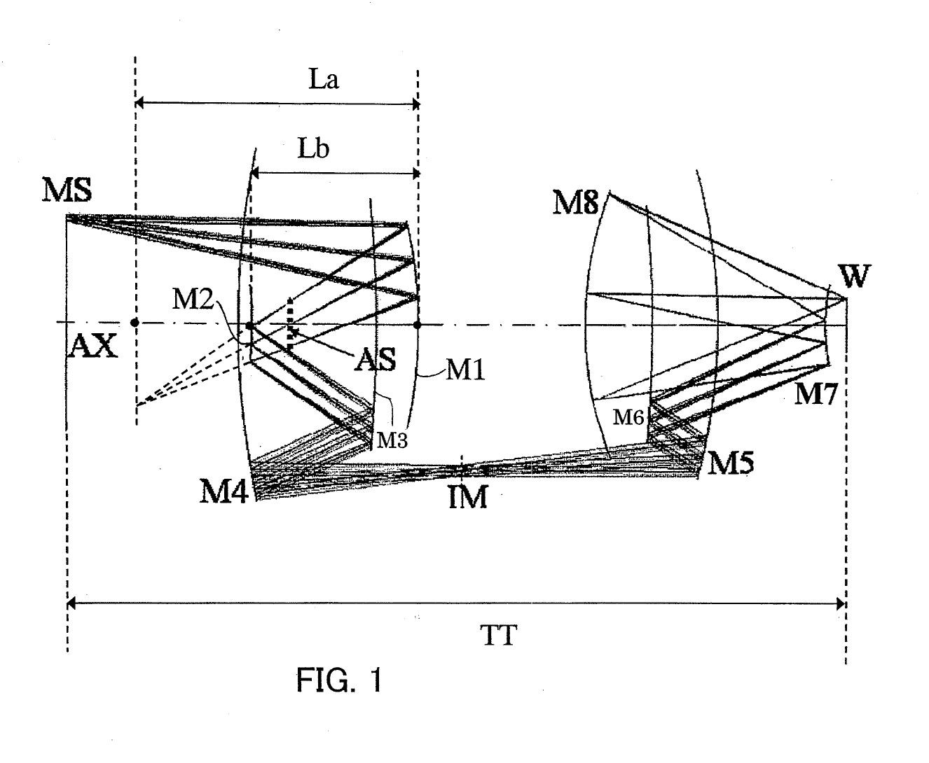

FIGS. 1 to 3 are cross-sectional views illustrating catoptric reduction projection optical systems according to the embodiments of the present invention and optical paths therein.

The catoptric reduction projection optical system projects a reduced image of a pattern on an object surface MS (for example, a mask surface) onto an image surface ‘W’ (for example, a surface of a substrate), the system being suitable specifically for the EUV light (a wavelength: 10 to 15 nm, more preferably 13.4 to 13.5 nm).

The catoptric reduction projection optical system includes eight mirrors (hereinafter also referred to as ‘reflective surface’ or ‘mirror’). More specifically, in the order of reflecting light from a side of the object surface MS (the object, or the pattern of the object), the system includes a first mirror M1 having a concave surface shape, a second mirror M2 having a convex surface shape, a third mirror M3 having a concave surface shape, and a fourth mirror M4 having a concave surface shape. Further, it includes a fifth mirror M5 having a concave surface shape, a sixth mirror M6 having a convex surface shape, a seventh mirror M7 having a convex surface shape, and an eighth mirror M8 having a concave surface shape.

An aperture stop AS is disposed, on the optical path between the first mirror M1 and the second mirror M2. The aperture stop AS is disposed at a position different from those of the first mirror M1 and the second mirror M2. When a length on an optical axis between the first mirror M1 and the second mirror M2 is defined as L12, the system is constituted such that a length (on the optical axis) from the second mirror M2 to the aperture stop AS is equal to or more than L12/15 and equal to or less than L12/2. The length from the second mirror M2 to the aperture stop AS may be equal to or more than L12/8 and equal to or less than L12/3.

Further, an intermediate image IM is formed on the optical path between the fourth mirror M4 and the fifth mirror M5.

As described above, as electronic circuits become finer, a higher NA of the projection optical system is required (for example, equal to or more than 0.3 of the NA). Further, due to the necessity of designing freedom for the aberration correction, the number of the mirrors has increased from conventional six to eight. Accordingly, the optical path becomes crowded. Moreover, as the NA becomes higher, a diameter of luminous flux increases. Accordingly, a size of an effective diameter of each reflective surface also increases. The aforementioned reasons have made it difficult to ensure the space for disposing members including a reflective surface, its holding mechanism, its cooling mechanism and the like. Moreover, ensuring the space for disposing the members largely restricts designing, thereby making an aberration correction difficult. Particularly, the cooling mechanism is crucial for the mirrors M1, M2, M3 and M4 that receives high light intensities, then ensuring the space for disposing the cooling mechanism is a significant subject.

To address these problems, for the following reasons, the first mirror M1 is formed in a concave surface shape, the second mirror M2 is formed in a convex surface shape, and further the aperture stop AS is disposed on the optical path between the first mirror M1 and the second mirror M2 in this embodiment. Moreover, in order to realize good imaging performance, the third mirror M3 has a concave surface shape.

A wide luminous flux from the object surface MS is appropriately converged by the concave surface of the first mirror M1 and introduced to the second mirror M2. Further the converged luminous flux is led to the subsequent reflective surfaces as the luminous flux having a substantially parallel width by the convex surface of the second mirror M2.

With this arrangement described above, sizes of optical effective portions of the second, third and fourth reflective surfaces M2, M3, M4 can be appropriately reduced, thereby enabling to ensure the space for disposing the members.

Further, as one affective method, at least either one of the following conditions (1) and (2) may be satisfied. An absolute value of a length on the optical axis between the first mirror M1 and a real image of a pattern on an object surface formed by the first mirror M1 is defined as La, an absolute value of a length between tops of the first mirror M1 and the second mirror M2 is defined as Lb, and an absolute value of a focal length of the second mirror M2 is defined as f2.

−0.3<{La−(Lb+f2)}/La<0.3 (1)

If a value of {La−(Lb+f2)}/La is smaller than the lower limit of the above condition (1), the excessively diffused luminous flux is emitted from the second mirror M2 and increases the sizes of the optical effective portions of the third and fourth reflective surfaces M3, M4, thereby possibly making it difficult to dispose the members. On the contrary, if the value is larger than the upper limit, the excessively converged luminous flux is emitted from the second mirror M2 and condensed near the third and the fourth mirrors M3, M4, thereby possibly causing problems that an image of dust on the reflective surfaces is transferred.

Now, a word of ‘real image’ is used for defining La, however, this real image does not need to actually form an image. More specifically, the word implies a real image when a real image of a pattern is formed only by the optical power of the first mirror M1, without the second and subsequent mirrors and other optical elements having optical powers.

0.4<Lb/La<0.6 (2)

If a value of Lb/La is smaller than the lower limit of the above condition (2), the diameter of the luminous flux entering the second mirror M2 increases, thereby possibly making it difficult to dispose the members near the second mirror M2. On the contrary, if the value is larger than the upper limit, the luminous flux excessively collect on the second mirror M2, thereby possibly causing problems that an image of dust on the second mirror M2 is transferred.

Generally, in order to ensure good image performance, object-side telecentricity needs to be reduced. In this case, the system is constituted such that the luminous flux having entered the first mirror M1 from the object surface passes very closely to the aperture stop AS. Further, the mirrors generally require high accuracy and large space for their auxiliary members such as holding members. On the other hand, however, the aperture stop does not require high accuracy but only small space for disposing its auxiliary members. In a case where the aperture stop coincides with the second mirror M2, the luminous flux passes near the second mirror M2, thereby causing a problem that the space for disposing the members can not be ensured.

On the other hand, the embodiment of the present invention disposes the aperture stop AS at a position apart from the second mirror M2, more specifically, on the optical path between the first mirror M1 and the second mirror M2 to ensure the space for disposing the members near the second mirror M2.

Further, in the aforementioned configuration, an incident angle of a ray onto the convex surface of the second mirror M2 is likely to increase, and thus the negative astigmatism may be generated. Therefore, in order to correct the astigmatism, the third mirror M3 has a concave surface shape to generate positive astigmatism, and to cancel the negative astigmatism. Further, if the third mirror M3 has the concave surface shape, diffusion of the luminous flux on the fourth mirror M4 can be suppressed, thereby easily reducing the maximum effective diameter of the light influx and easily ensuring the space for disposing the members.

Thus the following condition (3) may be met. Now, an overall length of the projection optical system on the optical axis AX is defined as TT, and an absolute value of a focal length of the third mirror M3 is defined as f3.

0.2<f3/TT<0.7 (3)

If a value of f3/TT is outside the above condition (3), the astigmatism generated on the second mirror M2 may not be corrected. As a result, a higher NA may not be realized. Specifically, if the value is smaller than the lower limit, the luminous flux excessively is condensed on the fourth mirror M4, thereby possibly causing a problem that an image of dusts is transferred. On the contrary, if the value is larger than the upper limit, the luminous flux excessively diffuses on the fourth mirror M4, thereby possibly causing problems that increasing the maximum effective diameter of the luminous flux and ensuring the space for disposing the members are difficult.

Here, in a case where the aperture stop AS is disposed on the optical path between the first mirror M1 and the second mirror M2, the following conditions may be met. That is, when a length of the optical path between the first mirror M1 and the second mirror M2 is defined as Lst, the aperture stop AS may be spaced away from each of the first and second reflective surfaces M1, M2 by equal to or more than Lst/10. Preferably, the aperture stop AS may be spaced away from each of the first and second reflective surfaces M1, M2 by equal to or more than Lst/5.

Employing this configuration makes it possible to ensure a more sufficient space for disposing the members between the second mirror M2 and the luminous flux entering the first mirror M1 from the object surface MS. The aperture stop AS can be disposed along the optical path such that the aperture stop AS is disposed closest to the second mirror M2 among the eight mirrors M1 to M8.

Further, as described above, forming the intermediate image IM on the optical path between the fourth mirror M4 and the fifth mirror M5 makes it possible to reduce a diameter of the luminous flux near the eighth mirror M8 having a large optical effective portion. Accordingly, the space for disposing the members can be easily ensured.

Here, the first to eighth mirrors M1 to M8 include eight reflective surfaces, of which the centers of curvature respectively align with each other on the optical axis AX. The center of curvature referred to herein, when the reflective surface is a spherical surface, means a center of the curvature of the spherical surface. However, when the surface is an aspheric surface, it means a center of the curvature of the spherical surface acquired by eliminating an aspheric surface component of the aspheric surface. In other words, it means a center of curvature based on the curvature near an axis of a rotation center on the reflective surface. Note that, when the reflective surface is spherical, all the straight lines passing the center of the spherical surface can be the axis of the rotation center, which may mean any of the axes. Additionally, when the reflective surface is aspheric, the axis of the rotation center means that of the aspheric surface in rotation symmetry including the reflective surface. Moreover, the spherical surface and the aspheric surface referred to herein include not only the spherical surface and aspheric surface in perfect shapes but also those in slightly deformed shapes that are still recognizable as they are.

It is advantageous that, since the eight reflective surfaces constitute a coaxial optical system in axis symmetry about basically one optical axis AX, an aberration may be corrected only in a region having a small ring shape about the optical axis. However, upon correcting or adjusting an aberration, the eight reflective surfaces constituting the catoptric reduction projection optical system do not need to be disposed to constitute a perfect coaxial system, but may slightly decenter to improve an aberration and freedom for arrangement.

The ray entering the first mirror M1 from the object surface MS can be non-telecentric, and the ray exiting from an image side is telecentric. This is because, in order to illuminate a reticle disposed on the object surface MS by an illumination optical system provided outside the figure to form the image on a wafer disposed on the image surface ‘W’, a certain incident angle is essentially required at the object side.

On the other hand, at the image side, it is because that being telecentric is desirable to reduce magnification fluctuates when the wafer to be disposed on the image surface ‘W’ travels in an optical axis direction.

Further, in order to increase the NA and keep a back focus to form the image, the seventh mirror M7 has the convex surface and the eighth mirror M8 has the concave surface.

Additionally, the fifth mirror M5 needs to be disposed closer to the optical axis so that the fourth mirror M4 leads the luminous flux to the fifth mirror M5 and its subsequent mirrors while avoiding the eighth mirror M8 having the large optical effective portion, and also reduces a size of an optical effective portion of the fifth mirror M5. Therefore, the fourth mirror M4 can be the concave surface shape.

Additionally, the fifth mirror M5 can be the concave surface shape to lead the luminous flux to the seventh and the eighth mirrors M7, M8 disposed near the optical axis.

Further when curvature radiuses of the eight mirrors described above are defined as r1 to r8 respectively, the sums of Petzval terms shown in the following expressions (4) and (5) need to be substantially zero.

$$\begin{matrix}\frac{1}{{r}_{1}} - \frac{1}{{r}_{2}} + \frac{1}{{r}_{3}} - \frac{1}{{r}_{4}} + \frac{1}{{r}_{5}} - \frac{1}{{r}_{6}} + \frac{1}{{r}_{7}} - \frac{1}{{r}_{8}} = 0 & ( 4 ) \\ \frac{1}{{r}_{1}} - \frac{1}{{r}_{2}} + \frac{1}{{r}_{3}} - \frac{1}{{r}_{4}} + \frac{1}{{r}_{5}} - \frac{1}{{r}_{6}} + \frac{1}{{r}_{7}} - \frac{1}{{r}_{8}} \approx 0 & ( 5 )\end{matrix}$$

The catoptric reduction projection optical system of the embodiment is constituted by the eight mirrors M1 to M8, of which at least one or more mirrors may have an aspheric surface. A shape of the aspheric surface can be expressed by a general expression shown as the following expression (6). However, considering from a viewpoint of aberration correction, as many numbers of the aspheric surfaces as possible are preferable, more preferably all of the eight mirrors have aspheric surfaces.

### [No. 3]

$$Z = \frac{{ch}^{2}}{1 + \sqrt{1 - ( 1 + k ) {c}^{2} {h}^{2}}} + {Ah}^{4} + {Bh}^{6} + {Ch}^{8} + {Dh}^{10} + {Eh}^{12} + {Fh}^{14} + {Gh}^{16} … \qquad ( 6 )$$

In the expression (6), ‘z’ denotes a coordinate in the optical axis direction, ‘c’ denotes a curvature (an inverse number of a curvature radius ‘r’), and ‘h’ denotes a height from the optical axis. ‘k’ denotes a conic constant, A, B, C, D, E, F and G respectively denote, coefficients of the aspheric surfaces of fourth, sixth, eighth, tenth, twelfth, fourteenth, and sixteenth.

The light used for the projection optical system of this embodiment is the EUV light having the wavelength in the range of 10 to 20 nm. The light can be the EUV light, of which the wavelength is preferably in the range of 13 to 14 nm.

Additionally, at least one reflective surface of the eight mirrors M1 to M8 is formed with multilayer films for reflecting the EUV light thereon. This utilizes a light enhancing effect. The multilayer films that can be used to reflect the EUV light having a wavelength of equal to or less than 20 nm include, for example, Mo/Si multilayer films formed by alternately laminating Molybdenum (Mo) and Silicon (Si), and Mo/Be multilayer films formed by alternately laminating Molybdenum (Mo) and Beryllium (Be). However, the multilayer films used in the embodiments of the present invention are not limited to those materials, but appropriate materials having similar effects to those described above for the wavelength used may be selected.

Further, due to characteristics of the layer films, when an incident angle of a ray is large, there arises a problem that a normal image cannot be formed by lowered reflectance. On the contrary, when the incident angle of the ray is too small, the luminous flux is shielded by the reflective surface, thereby making it difficult to lead the luminous flux from the object surface to the image surface. Therefore, the maximum value θ [degree] of the incident angle of the ray with respect to a surface normal at a point where the ray enters at each reflective surface can satisfy the following condition (7). θ may be equal to or smaller than 45 degrees.

θ<45 degrees (7)

The eight mirrors M1 to M8 can be disposed between the object surface and the image surface. That is to say, the eight reflective surfaces can be disposed between the object surface or an object side plane including the object surface and the image surface or an image side plane including the image surface.

Furthermore, all of the optical elements having optical powers of the catoptric reduction projection optical system can be disposed between the object surface and the image surface. This arrangement facilitates an arrangement of members such as a reticle stage and a wafer stage.

The surface vertexes of the eight mirrors M1 to M8 can be disposed in order of M4, M2, M3, M1, M8, M6, M5 and M7 from an object surface side to an image surface side along the optical axis AX. This facilitates an arrangement of members.

Note that condition (1) and subsequent conditions described above, are not necessarily satisfied as long as an intermediate image is formed on the optical path between the fourth mirror M4 and the fifth mirror M5.

The foregoing description and embodiments 1 to 3 to be described later describe the projection optical system having the eight mirrors. However, the present invention can be implemented as the projection optical system having equal to or more than eight mirrors.

The catoptric reduction projection optical system as an embodiment of the present invention described above is mounted in an exposure apparatus to be described later. The exposure apparatus includes an illumination optical system for illuminating a pattern of an object surface using the light from the light source, and the projection optical system described above for projecting a reduced image of the pattern on the objection surface onto the image surface. The exposure apparatus can be constituted such that a reflection mask is disposed on the object surface therein, and also can be constituted as a scanning exposure apparatus for synchronizing and scanning a mask stage and a wafer stage in a state where the object surface is illuminated with the EUV light.

### Embodiment 1

Next, the catoptric reduction projection optical system according to Embodiment 1 of the present invention shown in FIG. 1 will be described in detail.

The catoptric reduction projection optical system of this embodiment includes eight mirrors M1 to M8, this is to say, in order of light passing from an object surface MS, a first mirror M1 having a concave surface shape, an aperture stop AS, a second mirror M2 having a convex surface shape, a third mirror M3 having a concave surface shape, a fourth mirror M4 having a concave surface shape and a fifth mirror M5 having a concave surface shape. Additionally, it includes a sixth mirror M6 having a convex surface shape, a seventh mirror M7 having a convex surface shape and an eighth mirror M8 having a concave surface shape.

An intermediate image IM is formed on a light path between the fourth mirror M4 and the fifth mirror M5. Then, the intermediate image IM is re-formed on an image surface ‘W’ by the rest of the mirrors.

Actually, MS denotes a reflection mask disposed at a position of the object surface, and ‘W’ denotes a wafer disposed at a position of the image surface. The reflection mask illuminated by the illumination optical system is projected on the wafer disposed at the position of the image surface by the catoptric reduction projection optical system of this embodiment.

TABLE 1 shows Numerical Example 1 corresponding to Embodiment 1. In the Numerical Example 1, a length on the optical axis between the object surface and the image surface is referred to as an overall length, which is approximately 1089.84 mm.

An NA that is numerical aperture at an image side is 0.35. A magnification is ¼ times. An object height is 122.5 to 130.5 mm (viewing a field having an arc shape with a width 2 mm at the image side). A root mean square (RMS) of the wavefront aberration is 20.5 mλ. A distortion is within 1.7 nm.

As has been described, in the projection optical system of this embodiment, the wide luminous flux from the object surface is narrowed on the concave surface of the first mirror M1 before it enters the second mirror M2, and is further led to the third and fourth mirrors M3, M4 as a substantially parallel luminous flux that has been narrowed by the convex surface of the second mirror M2. Accordingly, the size of the optical effective portion of each reflective surface can be reduced to ensure the sufficient space for disposing the members.

In the expression (1), La=510.7 mm, Lb=235.8 mm, f2=195.9 mm. Then, {La−(Lb+f2)}/La=0.15 is obtained, which means that a substantially parallel luminous flux is emitted from the second mirror M2. In the expression (2), the numerical value Lb/La=0.46, which means that a spread of the luminous flux is appropriately suppressed on the second mirror M2.

Moreover, since the aperture stop AS is disposed between the first mirror M1 and the second mirror M2, the light having entered the first mirror M1 from the object surface is prevented from being shielded by the second mirror M2, although object-side telecentricity is maintained as small as 100 mrad. Accordingly, the space for disposing the members can be ensured near the second mirror M2.

f3/TT=0.60 is met in the expression (3), and enables the third mirror M3 to have an appropriate positive power. Thus, the astigmatism generated on the convex surface of the second mirror M2 is appropriately corrected.

Here, the aperture stop AS is disposed away from both of the first and second reflective surfaces M1, M2 by equal to or more than Lst/10, more preferably, equal to or more than Lst/5 in this embodiment. Accordingly, a large space for disposing the members can be ensured near the second mirror M2.

Moreover, the third mirror M3 has the concave surface shape and narrows the luminous flux from the second mirror M2, thereby reducing a light incident region on the fourth mirror M4, or the optical effective portion and facilitating processing and measurements. Additionally, a large space for disposing the members can be ensured.

Further, the fifth mirror M5 is disposed as close to the optical axis AX as possible in order to suppress the size of the optical effective portion thereof.

The fourth mirror M4 has the concave surface shape so that the luminous flux avoids the eighth mirror M8 having the large effective diameter and enters the fifth mirror M5. Additionally, in order to introduce the luminous flux from the fourth mirror M4 to the seventh and eighth mirrors M7, M8 disposed near the optical axis, the fifth mirror M5 has the concave surface shape and the sixth mirror M6 has the convex surface shape.

Further, forming the intermediate image IM on the optical path between the fourth and fifth mirrors M4, M5 prevents the luminous flux from being shielded by the eighth mirror M8 having the large effective diameter, thereby securing a space for disposing more members.

Moreover, each reflective surface of this embodiment is formed with multilayer films for reflecting the EUV light thereon. In order to ensure a predetermined reflectance for characteristics of the multilayer films, this embodiment suppresses θ in the expression (7) to approximately 30 degrees, although the NA is maintained as high as 0.35.

TABLE 1

| | CURVATURE | SURFACE |
|---|---|---|
| MIRROR NO. | RADIUS [mm] | SEPARATION [mm] |
| MS(MASK) | ∞ | 492.157 |
| M1 | −501.243 | −182.551 |
| AS(APERTURE STOP) | ∞ | −53.278 |
| M2 | −391.74 | 176.721 |
| M3 | −1318.31 | −195.158 |
| M4 | 962.652 | 675.097 |
| M5 | −619.47 | −91.4905 |
| M6 | −1234.85 | 238.341 |
| M7 | 221.101 | −331.547 |
| M8 | 391.705 | 361.547 |
| W (WAFER) | ∞ | 0 |

| ASPHERIC | | |
|---|---|---|
| SURFACES | | |
| CONSTANT | K | A |
| M1 | 1.36460E+00 | 1.16267E−10 |
| M2 | −1.35902E+01 | 1.13590E−08 |
| M3 | −4.62407E+00 | 1.69954E−09 |
| M4 | 6.13996E−01 | 4.03222E−10 |
| M5 | 4.65070E−01 | 7.80233E−10 |
| M6 | 1.40585E+01 | 1.30463E−09 |
| M7 | 3.46439E+00 | 8.21169E−09 |
| M8 | 6.83113E−02 | −4.09950E−11 |
| ASPHERIC | | |
| SURFACES | | |
| CONSTANT | B | C |
| M1 | 2.67693E−14 | −2.95379E−19 |
| M2 | 1.46743E−12 | −1.04863E−16 |
| M3 | −7.87497E−15 | 5.96690E−19 |
| M4 | −5.82193E−15 | 5.64203E−20 |
| M5 | 1.07435E−14 | 8.87678E−20 |
| M6 | 4.94239E−14 | 5.81708E−19 |
| M7 | −1.13729E−12 | 7.30309E−17 |
| M8 | −1.13426E−16 | −3.15165E−22 |
| ASPHERIC | | |
| SURFACES | | |
| CONSTANT | D | E |
| M1 | 1.39191E−23 | −8.55466E−28 |
| M2 | 9.69337E−20 | −4.84740E−23 |
| M3 | −4.20668E−24 | −4.47306E−29 |
| M4 | 4.80775E−25 | 9.61277E−30 |
| M5 | −5.55364E−25 | 7.26165E−29 |
| M6 | −7.03340E−24 | −1.75204E−27 |
| M7 | −3.48894E−20 | 1.35529E−23 |
| M8 | −1.10068E−26 | 6.23331E−31 |
| ASPHERIC | | |
| SURFACES | | |
| CONSTANT | F | G |
| M1 | 3.24569E−32 | −5.33155E−37 |
| M2 | 1.33150E−26 | −1.54923E−30 |
| M3 | 5.91860E−34 | 5.57371E−38 |
| M4 | −4.56309E−34 | 3.94635E−39 |
| M5 | −1.87857E−33 | 1.19630E−38 |
| M6 | 6.58265E−32 | −8.08934E−37 |
| M7 | −3.38322E−27 | 3.71554E−31 |
| M8 | −2.00380E−35 | 2.56728E−40 |

### Embodiment 2

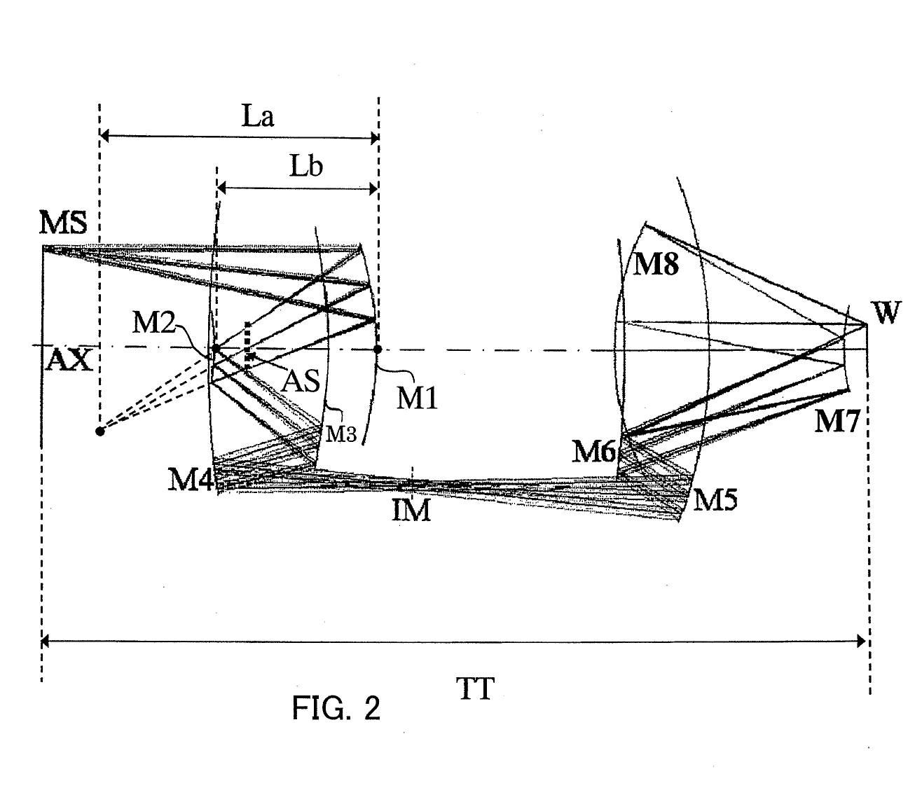

Next, the catoptric reduction projection optical system according to Embodiment 2 of the present invention shown in FIG. 2 will be described in detail.

The catoptric reduction projection optical system of this embodiment includes eight mirrors M1 to M8. This is to say, in order of light passing from an object surface MS, a first mirror M1 having a concave surface shape, an aperture stop AS, a second mirror M2 having a convex surface shape, a third mirror M3 having a concave surface shape, a fourth mirror M4 having a concave surface shape, and a fifth mirror M5 having a concave surface shape. Additionally, it includes a sixth mirror M6 having a convex surface shape, a seventh mirror M7 having a convex surface shape and an eighth mirror M8 having a concave surface shape.

An intermediate image IM is formed on the optical path between the fourth mirror M4 and the fifth mirror M5. Then, the intermediate image IM is re-imaged on an image surface ‘W’ by the rest of the mirrors.

Actually, MS denotes a reflection mask disposed at a position of the object surface, and ‘W’ denotes a wafer disposed at a position of the image surface. The reflection mask illuminated by the illumination optical system is projected on the wafer disposed at the position of the image surface by the catoptric reduction projection optical system of this embodiment.

TABLE 2 shows Numerical Example 2 corresponding to Embodiment 2. In the Numerical Example 2, a length on the optical axis between the object surface and the image surface is referred to as an overall length TT, which is approximately 1079.6 mm.

An NA that is numerical aperture at an image side is 0.4. A magnification is ¼ times. An object height is 122.5 to 130.5 mm (viewing field having an arc shape with a width 2 mm at the image side). A root mean square (RMS) of the wavefront aberration is 38.9 mλ. A distortion is within 5.7 nm.

As has been described, in the projection optical system of this embodiment, the wide luminous flux from the object surface is narrowed on the concave surface of the first mirror M1 before it enters the second mirror M2, and is further led to the third and fourth mirrors M3, M4 as a substantially parallel luminous flux that has been narrowed by the convex surface of the second mirror M2. Accordingly, the size of the optical effective portion of each reflective surface can be reduced to ensure the sufficient space for disposing the members.

In the expression (1), La=486.1 mm, Lb=213.3 mm, f2=138.6 mm. Then, {La−(Lb+f2)}/La=0.28 is obtained, which means that a substantially parallel luminous flux is emitted from the second mirror M2. In the expression (2), the numerical value Lb/La=0.44, which means that a spread of the luminous flux is appropriately suppressed on the second mirror M2.

Moreover, since the aperture stop AS is disposed between the first mirror M1 and the second mirror M2, the light having entered the first mirror M1 from the object surface is prevented from being shielded by the second mirror M2, although object-side telecentricity is maintained as small as 100 mrad. Accordingly, the space for disposing the members can be ensured near the second mirror M2.

f3/TT=0.30 is met in the expression (3), and enables the third reflecting mirror M3 to have an appropriate positive power. Thus, the astigmatism generated on the convex surface of the second mirror M2 is appropriately corrected.

Here, the aperture stop AS is disposed away from both of the first and second reflective surfaces M1, M2 by equal to or more than Lst/10, more preferably, equal to or more than Lst/5 in this embodiment. Accordingly, a large space for disposing the members can be ensured near the second mirror M2.

Moreover, the third mirror M3 has the concave surface shape and narrows the luminous flux from the second mirror M2, thereby reducing a light incident region on the fourth mirror M4 or the optical effective portion and facilitating processing and measurements. Additionally, a large space for disposing the members can be ensured.

Further, the fifth mirror M5 is disposed as close to the optical axis AX as possible in order to suppress the size of the optical effective portion thereof.

The fourth mirror M4 has the concave surface shape so that the luminous flux avoids the eighth mirror M8 having the large effective diameter and enters the fifth mirror M5. Additionally, in order to introduce the luminous flux from the fourth mirror M4 to the seventh and eighth mirrors M7, M8 disposed near the optical axis, the fifth mirror M5 has the concave surface shape and the sixth mirror M6 has the convex surface shape.

Further, forming the intermediate image IM on the optical path between the fourth and fifth mirrors M4, M5 prevents the luminous flux from being shielded by the eighth mirror M8 having the large effective diameter, thereby securing a space for disposing more members.

Moreover, each reflective surface of this embodiment is formed with multilayer films for reflecting the EUV light thereon. In order to ensure a predetermined reflectance for characteristics of the multilayer films, this embodiment suppresses θ in the expression (7) to approximately 35 degrees, although the NA is maintained as high as 0.4.

TABLE 2

| | CURVATURE | SURFACE |
|---|---|---|
| MIRROR NO. | RADIUS [mm] | SEPARATION [mm] |
| MS(MASK) | ∞ | 436.309 |
| M1 | −459.839 | −170.399 |
| AS(APERTURE STOP) | ∞ | −42.946 |
| M2 | −277.122 | 149.858 |
| M3 | −651.326 | −157.253 |
| M4 | 1406.72 | 661.536 |
| M5 | −636.539 | −111.5 |
| M6 | −1616.33 | 283.999 |
| M7 | 225.724 | −296.419 |
| M8 | 356.827 | 326.419 |
| W (WAFER) | ∞ | 0 |

| ASPHERIC | | | |
|---|---|---|---|
| SURFACES | | | |
| CONSTANT | K | A | B |
| M1 | 1.54636E+00 | −1.04215E−10 | 1.60902E−14 |
| M2 | −8.43130E+00 | 1.57593E−09 | 4.09161E−12 |
| M3 | −1.08945E+00 | 1.76743E−10 | 9.76625E−14 |
| M4 | −1.15320E+01 | −2.66415E−10 | 3.00086E−14 |
| M5 | 1.09473E+00 | 1.81069E−10 | 1.47624E−14 |
| M6 | 4.24695E+01 | 1.77137E−10 | 1.98974E−15 |
| M7 | 3.85960E+00 | 1.62050E−08 | −5.88830E−13 |
| M8 | 7.36826E−02 | −2.02435E−11 | 3.29971E−17 |
| ASPHERIC | | | |
| SURFACES | | | |
| CONSTANT | C | D | E |
| M1 | −1.80083E−19 | 3.86987E−23 | −2.86628E−27 |
| M2 | −7.16107E−16 | 7.62182E−19 | −5.18010E−22 |
| M3 | −3.82342E−18 | −6.02946E−24 | 9.74882E−27 |
| M4 | −1.96689E−19 | −1.55355E−23 | 2.09806E−28 |
| M5 | −9.05633E−20 | −4.08025E−24 | 1.05211E−28 |
| M6 | 6.85913E−19 | −4.48489E−25 | −1.55802E−27 |
| M7 | −1.53340E−18 | 1.92313E−20 | −1.53244E−23 |
| M8 | 2.43399E−22 | 4.84896E−26 | −1.04769E−30 |
| ASPHERIC | | | |
| SURFACES | | | |
| CONSTANT | F | G | H |
| M1 | 1.29219E−31 | −3.28748E−36 | 3.65803E−41 |
| M2 | 2.07690E−25 | −4.56737E−29 | 4.24171E−33 |
| M3 | −4.63883E−31 | 9.57738E−36 | −7.65182E−41 |
| M4 | 1.39446E−32 | −4.26391E−37 | 3.54046E−42 |
| M5 | 1.30295E−34 | −2.47119E−38 | 1.95057E−43 |
| M6 | 9.49218E−32 | −2.42822E−36 | 2.37195E−41 |
| M7 | 7.35992E−27 | −1.90317E−30 | 2.05627E−34 |
| M8 | 2.81594E−35 | −4.61140E−40 | 5.24953E−45 |

### Embodiment 3

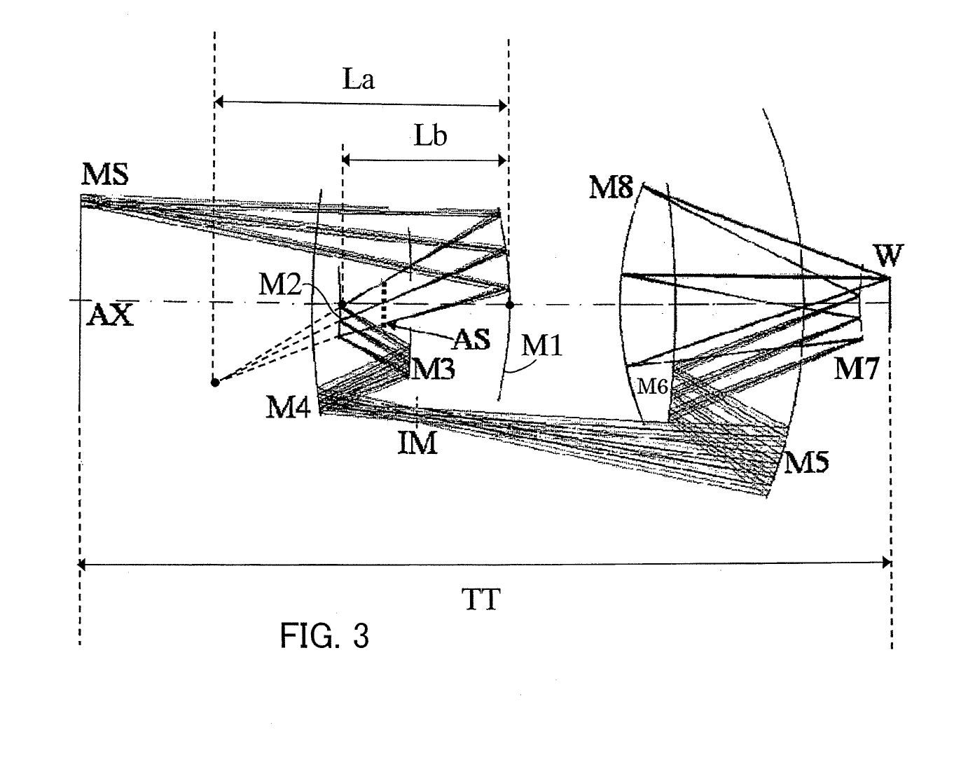

Next, the catoptric reduction projection optical system according to Embodiment 3 of the present invention shown in FIG. 3 will be described in detail.

The catoptric reduction projection optical system of this embodiment includes eight mirrors M1 to M8. This is to say, in order of light passing from an object surface MS, a first mirror M1 having a concave surface shape, an aperture stop AS, a second mirror M2 having a convex surface shape, a third mirror M3 having a concave surface shape, a fourth mirror M4 having a concave surface shape, and a fifth mirror M5 having a concave surface shape. Additionally, it includes a sixth mirror M6 having a convex surface shape, a seventh mirror M7 having a convex surface shape and an eighth mirror M8 having a concave surface shape.

An intermediate image IM is formed on the optical path between the fourth mirror M4 and the fifth mirror M5. Then, the intermediate image IM is re-imaged on an image surface ‘W’ by the rest of the mirrors.

Actually, MS denotes a reflection mask disposed at a position of the object surface, and ‘W’ denotes a wafer disposed at a position of the image surface. The reflection mask illuminated by the illumination optical system is projected on the wafer disposed at the position of the image surface by the catoptric reduction projection optical system of this embodiment.

TABLE 3 shows Numerical Example 3 corresponding to Embodiment 3. In the Numerical Example 3, a length on the optical axis between the object surface and the image surface is referred to as an overall length TT, which is approximately 1096.0 mm.

An NA that is numerical aperture at an image side is 0.32. A magnification is ¼ times. An object height is 119.5 to 133.5 mm (viewing field having an arc shape with a width 3.5 mm at the image side). A root mean square (RMS) of the wavefront aberration is 13.7 mλ. A distortion is within 1.0 nm.

As has been described, in the projection optical system of this embodiment, the wide luminous flux from the object surface is narrowed on the concave surface of the first mirror M1 before it enters the second mirror M2, and is further led to the third and fourth mirrors M3, M4 as a substantially parallel luminous flux that has been narrowed by the convex surface of the second mirror M2. Accordingly, the size of the optical effective portion of each mirror can be reduced to ensure the sufficient space for disposing the members.

In the expression (1), La=425.3 mm, Lb=231.7 mm, f2=189.0 mm. Then, {La−(Lb+f2)}/La=0.01 is obtained, which means that a substantially parallel luminous flux is emitted from the second mirror M2. In the expression (2), the numerical value Lb/La=0.54, which means that a spread of the luminous flux is appropriately suppressed on the second mirror M2.

Moreover, since the aperture stop AS is disposed between the first mirror M1 and the second mirror M2, the light having entered the first mirror M1 from the object surface is prevented from being shielded by the second mirror M2, although object-side telecentricity is maintained as small as 100 mrad. Accordingly, the space for disposing the members can be ensured near the second mirror M2.

f3/TT=0.53 is met in the expression (3), and enables the third reflecting mirror M3 to have an appropriate positive power. Thus, the astigmatism generated on the convex surface of the second mirror M2 is appropriately corrected.

Here, the aperture stop AS is disposed away from both of the first and second reflective surfaces M1, M2 by equal to or more than Lst/10, more preferably, equal to or more than Lst/5 in this embodiment. Accordingly, a large space for disposing the members can be ensured near the second mirror M2.

Moreover, the third mirror M3 has the concave surface shape and narrows the luminous flux from the second mirror M2, thereby reducing a light incident region on the fourth mirror M4 or the optical effective portion and facilitating processing and measurements. Additionally, a large space for disposing the members can be ensured.

Further, the fifth mirror M5 is disposed as close to the optical axis AX as possible in order to suppress the size of the optical effective portion thereof.

The fourth mirror M4 has the concave surface shape so that the luminous flux avoids the eighth mirror M8 having the large effective diameter and enters the fifth mirror M5. Additionally, in order to introduce the luminous flux from the fourth mirror M4 to the seventh and eighth mirrors M7, M8 disposed near the optical axis, the fifth mirror M5 has the concave surface shape and the sixth mirror M6 has the convex surface shape.

Further, forming the intermediate image IM on the optical path between the fourth and fifth mirrors M4, M5 prevents the luminous flux from being shielded by the eighth mirror M8 having the large effective diameter, thereby securing a space for disposing more members.

Moreover, each reflective surface of this embodiment is formed with multilayer films for reflecting the EUV light thereon. In order to ensure predetermined reflectance for characteristics of the multilayer films, this embodiment suppresses θ in the expression (7) to approximately 29 degrees, although the NA maintained is as high as 0.32.

TABLE 3

| | CURVATURE | SURFACE |
|---|---|---|
| MIRROR NO. | RADIUS [mm] | SEPARATION [mm] |
| MS(MASK) | ∞ | 582.785 |
| M1 | −491.751 | −175.884 |
| AS(APERTURE STOP) | ∞ | −55.776 |
| M2 | −378.055 | 96.4838 |
| M3 | −1161.98 | −134.74 |
| M4 | 955.996 | 670.389 |
| M5 | −604.656 | −173.926 |
| M6 | −1160.03 | 247.075 |
| M7 | 217.005 | −321.322 |
| M8 | 390.085 | 360.924 |
| W (WAFER) | ∞ | 0 |

| ASPHERIC | | | |
|---|---|---|---|
| SURFACES | | | |
| CONSTANT | K | A | B |
| M1 | 1.17970E+00 | 4.09739E−10 | 1.82594E−14 |
| M2 | −1.34934E+01 | 1.15993E−08 | 2.22117E−12 |
| M3 | −2.05913E+01 | 2.98233E−09 | 1.34552E−13 |
| M4 | −2.49453E+00 | −1.46829E−11 | 2.69205E−14 |
| M5 | 8.45435E−01 | 5.08054E−10 | 5.87706E−15 |
| M6 | 1.41523E+01 | 1.45771E−09 | 1.44172E−14 |
| M7 | 3.19024E+00 | 2.36892E−09 | −1.32366E−12 |
| M8 | 7.12161E−02 | −3.20957E−11 | −9.16412E−17 |
| ASPHERIC | | | |
| SURFACES | | | |
| CONSTANT | C | D | E |
| M1 | −1.69084E−20 | −8.18336E−24 | 8.61493E−28 |
| M2 | −2.63938E−16 | 2.04763E−19 | −1.09652E−22 |
| M3 | −9.97107E−18 | 8.64145E−22 | 2.86235E−26 |
| M4 | −3.79724E−19 | −2.11601E−23 | 9.13466E−28 |
| M5 | −1.84860E−20 | −1.89129E−24 | 8.08683E−29 |
| M6 | −2.05929E−19 | 2.48049E−23 | −1.31497E−27 |
| M7 | 3.74839E−18 | −9.34056E−21 | −1.23005E−24 |
| M8 | 1.90252E−21 | −2.61859E−25 | 2.04553E−29 |
| ASPHERIC | | | |
| SURFACES | | | |
| CONSTANT | F | G | H |
| M1 | −5.09708E−32 | 1.97265E−36 | −3.74935E−41 |
| M2 | 3.43514E−26 | −5.32730E−30 | 2.32975E−34 |
| M3 | −1.05889E−29 | 8.08105E−34 | −2.16389E−38 |
| M4 | 3.47478E−32 | −2.43949E−36 | 3.85529E−41 |
| M5 | −1.40695E−33 | 1.21255E−38 | −4.23127E−44 |
| M6 | 2.55676E−32 | 1.39580E−37 | −7.89923E−42 |
| M7 | 1.35010E−27 | −5.76840E−31 | 9.90060E−35 |
| M8 | −9.36667E−34 | 2.32350E−38 | −2.39668E−43 |

As described above, according to each aforementioned embodiment, although the diameter of the luminous flux is increased and the size of the effective diameter of each reflective surface is increased as the NA becomes higher, the sufficient space for disposing the members such as a mirror, a holding mechanism and a cooling mechanism can be ensured. As a result of this, designing restrictions are reduced, and aberration correction can be well performed. Therefore, the projection optical system provided with equal to or more than eight mirrors having the higher NA and good image performance can be realized.

### Embodiment 4

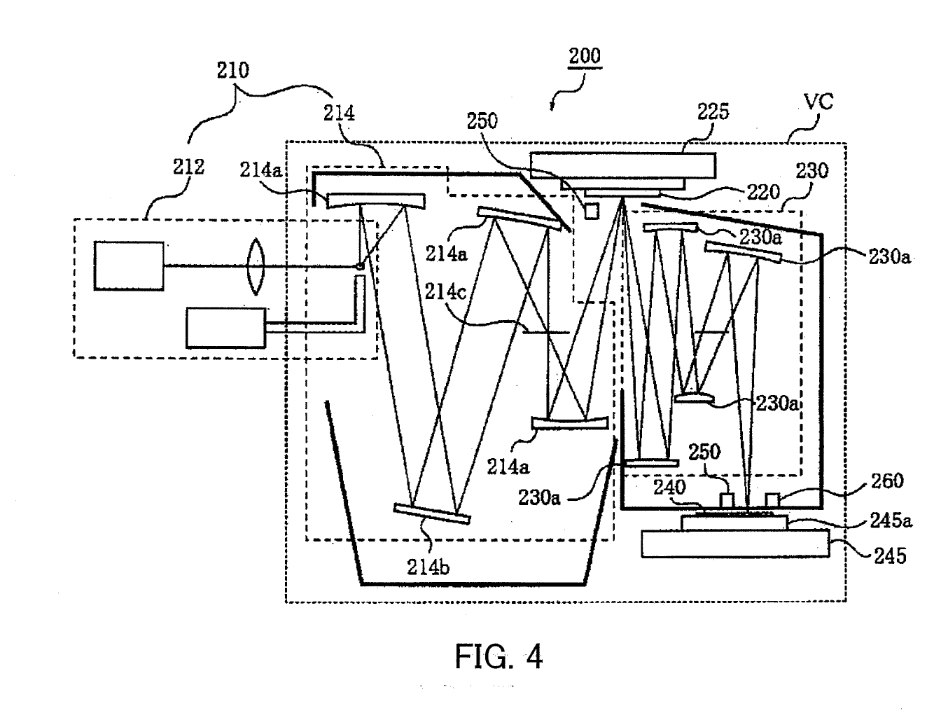

Next, an example of a projection exposure apparatus 200 in which the projection optical system shown in aforementioned Embodiments 1 to 3 is applied will be described with reference to FIG. 4.

The exposure apparatus 200 of this embodiment uses the EUV light, for example its wavelength is 13.5 nm, as illumination light for exposing to expose onto a substrate 240 a circuit pattern formed on a mask 220, for example by a step-and-scan method or a step-and-repeat method. This exposure apparatus is suitable for the lithography processing in a size of smaller than submicron or quarter micron. Hereinafter, this embodiment will describe the exposure apparatus, also referred to as a scanner, by the step-and-scan method as an example. Here, the step-and-scan method refers to an exposure method for continuously scanning a wafer for a mask to expose a pattern on the mask, and for moving the wafer to a next exposure region by a step movement after one shot for exposing is completed. The step-and-repeat method refers to an exposure method for moving a wafer by a step movement for every one-shot exposure of the wafer, and then move the wafer to a next exposure region.

Referring to FIG. 4, the exposure apparatus 200 includes an illumination apparatus 210 for illuminating a mask 220 with light from a light source, a mask stage 225 for mounting the mask 220 and a projection optical system 230 for leading the light from the mask 220 to a substrate 240. It further includes a wafer stage 245 for mounting the substrate 240, an alignment detection mechanism 250 and a focus position detection mechanism 260. Here, FIG. 4 shows four mirrors between the mask at which the light is reflected and the substrate (wafer) which the light reaches after the reflection in the catoptric reduction projection optical system. This is because to simplify the figure, but actually equal to or more than eight mirrors are provided as shown in Embodiments 1 to 3.

Further, as shown in FIG. 4, since the EUV has low transmissivity with respect to atmosphere, it generates contamination by reacting to residual gas (polymer organic gas and the like). Thus, at least an inside of a path through which the EUV light passes, that is an entire optical system, is kept in vacuum atmosphere (VC).

The illumination apparatus 210 illuminates the mask 220 with the EUV light, for example its wavelength is 13.4 nm, having an arc shape with respect to a view field having an arc shape of the projection optical system 230, and includes an EUV light source 212 and an illumination optical system 214.

An EUV source 212 employs, for example, a laser plasma source. This is to radiate a target member in a vacuum container with high-intensity pulse laser beam to generate high-temperature plasma, which radiates the EUV light, for example its wavelength is approximately 13 nm. The target member includes a metal layer, gas jet and liquid drop. In order to improve the average strength of the EUV light that is radiated, higher cyclic frequency of the pulse laser is desirable. And the EUV source 212 is normally driven at a cyclic frequency of several kHz.

The illumination optical system 214 is constituted by a condenser mirror 214a and an optical integrator 214b. The condenser mirror 214a collects the EUV light that has been substantially isotopically radiated from laser plasma. The optical integrator 214b illuminates the mask 220 uniformly with a predetermined NA. Further, the illumination optical system 214 is provided with an aperture 214c for restraining an illumination region of the mask 220 into an arc shape at a position conjugate with the mask 220. There may be provided a cooling apparatus for cooling the condenser mirror 214a and an optical integrator 214b that are optical members constituting the illumination optical system 214. A condenser mirror 214a and an optical integrator 214b are cooled and its deformation caused by thermal expansions is prevented, thereby being able to realize good imaging performance.

The mask 220 is a reflection mask, and is formed with a circuit pattern, or image, to be transferred thereon. The mask 220 is supported and driven by a mask stage 225. Diffracted light emitted from the mask 220 is reflected by the projection optical system 230 described in Embodiments 1 to 3 and then is projected onto the substrate 240. The mask 220 and the substrate 240 are disposed in an optically conjugate relationship. Since the exposure apparatus 200 employs the step-and-scan method, it projects a reduced pattern of the mask 220 onto the substrate 240 by scanning the mask 220 and the substrate 240.

The mask stage 225 supports the mask 220 and is connected to a moving mechanism (not shown). The mask stage 225 can adopt any kinds of structures. The moving mechanism (not shown) is constituted by a linear motor or the like, and can move the mask 220 by driving the mask stage in an, at least, X direction. The exposure apparatus 200 scans in a state where the mask 220 and the substrate 240 are synchronized.

The projection optical system 230 employs a plurality of mirrors 230a that are multiple layered mirrors to reducingly project the pattern on a surface of the mask 220 onto the substrate 240 that is an image surface. The number of the plurality of mirrors 230a is equal to or more than eight as described above. In order to realize a wide exposure range with as smaller number of mirrors as possible, only a narrow region having an arc shape (field having a ring shape) located away from the optical axis by a certain length is used to transfer a wide area by simultaneously scanning the mask 220 and the substrate 240. The NA of the projection optical system 230 is between approximately 0.3 and 0.5. The mirror 230a that is an optical member constituting the projection optical system 230 may be cooled using the cooling apparatus. The mirror 230a is cooled and its deformation caused by thermal expansions is prevented, thereby being able to realize good image-forming performance.

The substrate 240 refers to the wafer in this embodiment, however, it widely includes a liquid substrate and other kinds of substrates. A photoresist is applied on the substrate 240.

The wafer stage 245 supports the substrate 240 with a wafer chuck 245a. The wafer stage 245 moves the substrate 240 in X, Y, and Z directions, for example, using the linear motor. The mask 220 and the substrate 240 are synchronously scanned. Positions of the mask stage 225 and the wafer stage 245 are monitored by, for example laser interferometers, and both are driven at a certain velocity ratio.

An alignment detection mechanism 250 measures a positional relationship between the mask 220 and the optical axis of the projection optical system 230, and that between the substrate 240 and the optical axis of the projection optical system 230. The positions of and an angle between the mask stage 225 and the wafer stage 245 are set such that a position of a projected image of the mask 220 coincides with a predetermined position of the substrate 240.

A focus position detection mechanism 260 measures a focus position on a surface of the substrate 240, and controls the position and the angle of the wafer stage 245 so as to always maintain the surface of the substrate 240 at a position where the image is formed by the projection optical system 230 during exposure.

During exposure, the EUV light emitted from the illumination apparatus 210 illuminates the mask 220 to form the pattern on the surface of the mask 220 onto a surface of the substrate 240. In this embodiment, the image surface has an arc shape (having a ring shape), and scans the mask 220 and the substrate 240 at a speed ratio of a reduction magnification ratio to expose an entire surface of the mask 220.

Here, since the exposure apparatus has sensitive optical performance about changing a shape of an optical member of the projection optical system, the cooling apparatus is often used for the optical member (mirror) of the projection optical system. Particularly, it is often used for the optical members at a side of the mask where a large amount of light is collected. However, it may be also used for the illumination optical system. Particularly, since the largest amount of light enters the reflective optical member, among all the optical members, disposed closest to the light source, an amount of absorbed heat inevitably becomes large. Thus, an amount of the changed shape of the optical member by the absorbed heat also becomes large.

In order to prevent this, the aforementioned cooling apparatus can prevent a temperature rise caused by a large amount of absorbed light to reduce temperature difference of the optical member, thereby being able to suppress the shape changing.

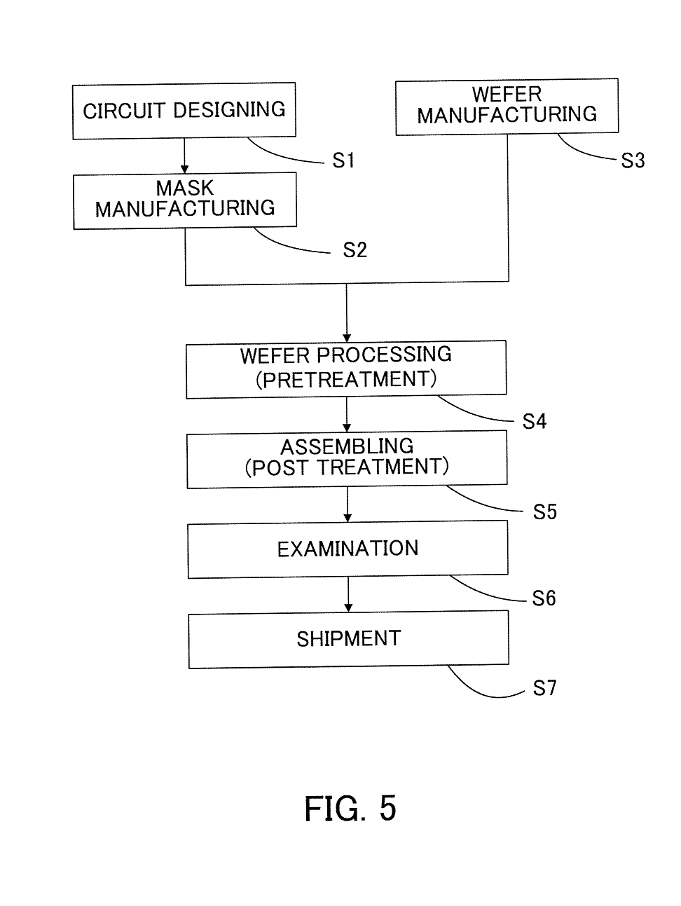

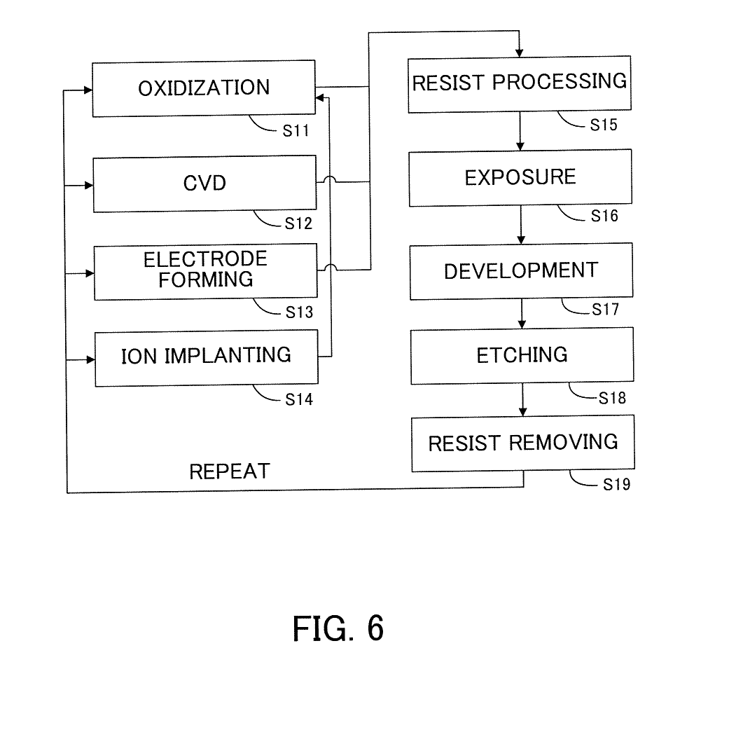

Next, referring to FIGS. 5 and 6, an embodiment of a method for manufacturing devices using the aforementioned exposure apparatus 200 will be described. FIG. 5 is a flowchart for describing manufacturing devices including LCDs, CCDs, and semiconductor chips such as ICs and LSIs. This embodiment will describe an example for manufacturing the semiconductor chips. In step 1 (DESIGNING CIRCUIT), a circuit of a device is designed. In step 2 (MANUFACTURING MASK), a mask on which a pattern of the designed circuit is formed is manufactured. In step 3 (MANUFACTURING WAFER), a wafer is manufactured using materials such as silicon. In step 4 (PROCESSING WAFER) referred to as a previous process, in which an actual circuit is formed on the wafer using the mask and the wafer by lithography technology. In step 5 (ASSEMBLING) referred to as a post process, in which the wafer manufactured in step 4 is processed into a semiconductor chip. The step 5 includes processes such as an assembly process (dicing, bonding) and a package process (enclosing a chip). In step 6 (EXAMINATION), tests of operation confirmation and durability about the semiconductor device manufactured in step 5 is examined. Through these processes, the semiconductor device is completed and shipped out in step 7 (SHIPMENT).

FIG. 6 is a flowchart in detail for describing wafer processing in step 4. In step 11 (OXIDIZATION), a surface of the wafer is oxidized. In step 12 (CVD), an insulation layer is formed on the surface of the wafer. In step 13 (ELECTRODE FORMING), an electrode is formed on the wafer by evaporation or the like. In step 14 (ION IMPLANTING), ion is implanted into the wafer. In step 15 (RESIST PROCESSING), photosensitizing agent is applied on the wafer. In step 16 (EXPOSURE), the circuit pattern on the mask is exposed onto the wafer by the exposure apparatus 200. In step 17 (DEVELOPMENT), the exposed wafer is developed. In step 18 (ETCHING), a portion other than a developed resist image is shaved off. In step 19 (RESIST REMOVING), the unnecessary resist after completing etching is removed. Repeating these steps forms the multi-layered circuit pattern on the wafer.

According to the method for manufacturing the device of this embodiment, the device having higher quality than that of conventional ones can be manufactured. As described above, the method for manufacturing the device using the exposure apparatus 200 and also the device itself as a resulted production constitute one aspect of the present invention.

For example, the cooling apparatus of the present invention can be applied to an optical member for ultra-violet rays whose wavelength is equal to or less than 200 nm, other than the EUV light such as the ArF Excimer laser and F2 laser. And the cooling apparatus can also be applied to a mask and a wafer.

Furthermore, the present invention is not limited to these embodiments and various variations and modifications may be made without departing from the scope of the present invention.

This application claims the benefit of Japanese Patent Application No. 2007-100112, filed on Apr. 6, 2007 which is hereby incorporated by reference herein in its entirety.

What is claimed is:

1. A projection optical system configured to project a reduced image of a pattern on an object onto an image surface, the projection optical system comprising, in order of reflecting light from the object:
a first reflective surface having a concave surface shape, a second reflective surface having a convex surface shape, a third reflective surface having a concave surface shape, a fourth reflective surface, a fifth reflective surface, a sixth reflective surface, a seventh reflective surface, and an eighth reflective surface, and
an aperture stop disposed on an optical path between the first reflective surface and the second reflective surface,
wherein an intermediate image is formed on an optical path between the fourth reflective surface and the fifth reflective surface.

2. A projection optical system according to claim 1, which satisfies −0.3<{La−(Lb+f2)}/La<0.3, where La denotes an absolute value of a length on an optical axis between the first reflective surface and a real image of the pattern of the object formed by the first reflective surface, Lb denotes an absolute value of a length between vertexes of the first reflective surface and the second reflective surface, and f2 denotes an absolute value of a focal length of the second reflective surface.

3. A projection optical system according to claim 1, which satisfies 0.4<Lb/La<0.6, where La denotes an absolute value of a length on an optical axis between the first reflective surface and a real image of the pattern of the object formed by the first reflective surface, and Lb denotes an absolute value of a length between vertexes of the first reflective surface and the second reflective surface.

4. A projection optical system according to claim 1, which satisfies 0.2<f3/TT<0.7, where TT denotes an overall length of the projection optical system on an optical axis, and f3 denotes an absolute value of a focal length of the third reflective surface.

5. A projection optical system according to claim 1, wherein the fourth reflective surface has a concave surface shape.

6. A projection optical system according to claim 1, wherein the fifth reflective surface has a concave surface shape.

7. A projection optical system according to claim 1, wherein the sixth reflective surface has a convex surface shape.

8. A projection optical system according to claim 1, wherein the seventh reflective surface has a convex surface shape.

9. A projection optical system according to claim 1, wherein the eighth reflective surface has a concave surface shape.

10. A projection optical system according to claim 1, wherein a maximum value of an incident angle of a ray on each of the reflective surface is 45 degrees or smaller.

11. A projection optical system according to claim 1, wherein the aperture stop is distant from the first reflective surface and the second reflective surface by Lst/10 or greater, where Lst is a length of the optical path between the first reflective surface and the second reflective surface.

12. An exposure apparatus comprising:
an illumination optical system configured to illuminate a pattern of an object using light from a light source; and
a projection optical system according to claim 1 configured to project a reduced image of the pattern onto an image surface.

13. A method for manufacturing a device comprising the steps of:
exposing a substrate using an exposure apparatus including an illumination optical system configured to illuminate a pattern of an object using light from a light source, and a projection optical system according to claim 1 configured to project a reduced image of the pattern onto an image surface; and
developing the substrate that has been exposed.
